(19) United States
(12) Patent Application Publication
(10) Pub. No.: US 2026/0200319 A1
(43) Pub. Date: Jul. 16, 2026

(54) CONTROL DEVICE FOR A VEHICLE AND ASSOCIATED VEHICLE

(71) Applicant: EYELIGHTS, LABEGE (FR)

(72) Inventors: Patrice Steve Dominique NAGTEGAELE, ESCALQUENS (FR); Romain François Christophe DUFLOT, CASTANET TOLOSAN (FR)

(21) Appl. No.: 19/133,532

(22) PCT Filed: Dec. 1, 2023
(86) PCT No.: PCT/EP2023/083955

§ 371 Date: May 28, 2025

(30) Foreign Application Priority Data
Dec. 1, 2022 (FR) 2212634

(51) Int. Cl. B60K 35/231

(52) U.S. Cl. CPC B60K 35/231

(57) ABSTRACT

Control device (16) suitable for integration into a vehicle (10) to display control information of the vehicle (10), the control device (16) comprising:
a. an opaque panel (20) having a useful surface (21), at least part of which is suitable for being positioned opposite the upper body of a driver (18) in the driving position,
b. a reflective element covering the useful surface (21) of the opaque panel (20), the reflective element being at least partially reflective, and
c. an emission unit (24) for control information of the vehicle (10), the emission unit (24) being suitable for emitting at least one light beam towards the reflective element so that the reflection of the light beam on the reflective element forms at least one useful image in an observation window of the driver (18) in the driving position.

The present invention relates to a control device for a vehicle. The present invention also relates to a vehicle comprising such a control device.

Vehicles, notably automobiles, are equipped with control devices, also called instrument clusters or dashboards, to present the driver with useful information for driving and operating the vehicle. For this purpose, the control device comprises the dashboard instruments of the vehicle, some of said instruments being imposed by legislation.

For an automobile, the control device is traditionally integrated into the dashboard of the vehicle under the windshield, behind the steering wheel. Typically, such a control device is positioned at least at −15° from the line of sight of an average driver looking at the road, about 50 centimeters from the eyes. The driver is then required to take their eyes off the road to view the control device, which decreases vigilance and increases eye fatigue due to the constant visual accommodation effort required.

To allow safer visualization of useful information, it is known to use head-up displays that retransmit some information from the control device to the driver.

However, such displays occupy additional space in the vehicle, redundant with the control device, and some are very bulky. Moreover, these displays provide visualization of the useful image only within a restricted observation window (eyebox).

Additionally, the visibility of the useful image generated by these displays depends on ambient brightness. Thus, in case of high brightness (sunny weather), the visibility of the useful image is often reduced because the power of the projection screen is not sufficient. One possibility would be to increase the brightness of the projection screen. However, this would lead to increased energy costs and heating. Moreover, projection screens are limited in power.

An alternative is to replace mechanical dashboard instruments with digital dashboard instruments. For this purpose, control devices in the form of screens are known. The trend is to position such control devices higher in the driver's field of vision to reduce the look-down angle of the dashboard instruments.

However, such control devices then obscure part of the vehicle's windshield, and notably part of the driver's field of vision, which is not optimal in terms of driving comfort and safety.

There is therefore a need for a vehicle control device allowing useful driving information to be displayed in a comfortable observation window for the driver without affecting driving safety.

To this end, the present description aims at a control device suitable for integration into a vehicle to display vehicle control information, including all the dashboard instruments, of the vehicle, the control device comprising:
an opaque panel having a useful surface, at least part of which is suitable for being positioned opposite the upper body of a driver in the driving position,
a reflective element covering the useful surface of the opaque panel, the reflective element being at least partially reflective, and
an emission unit for vehicle control information, the emission unit being suitable for emitting at least one light beam towards the reflective element so that the reflection of the light beam on the reflective element forms at least one useful image in an observation window of the driver in the driving position.

According to other advantageous aspects, the control device comprises one or more of the following features, taken individually or in any technically possible combinations:
the vehicle comprises a windshield comprising a transparent surface and a screen-printed area surrounding the transparent surface, the screen-printed area comprising a lower part having a base and a raised portion protruding from the base, the opaque panel being formed by the raised portion;
the vehicle comprises pillars connected to the lateral portions of the windshield base, the raised portion comprising a strip protruding from the base and extending substantially over the width of the transparent surface except for the ends of the base of the screen-printed area which are clear, so as to clear the visibility of the environment at the pillars of the vehicle;
the raised portion comprises a raised area more raised than the strip and protruding from the strip, the raised area being an area opposite the upper body of the driver in the driving position;
the control device is suitable for integration into the dashboard of the vehicle;
the emission unit is suitable for emitting, towards the reflective element, a polarized light beam according to a main polarization, called the incident beam, the incident beam arriving on the reflective element with an angle of incidence and defining with the reflective element a plane of incidence, the main polarization being a polarization contained in the plane of incidence, called P polarization, the reflective element being optimized to have greater reflectivity, over a range of angles of incidence comprising the angle of incidence, for P-polarized light than for a non-optimized reflective element;
the reflective element has greater reflectivity, over the range of angles of incidence, for P-polarized light than for differently polarized light;
the control device is configured to be automatically turned on when the vehicle is started and to be automatically turned off when the vehicle is turned off.

The present description also relates to a vehicle wherein a control device as described above is integrated.

Optionally, the dashboard of the vehicle is devoid of mechanical dashboard instruments integrated into the dashboard and digital dashboard instruments integrated into the dashboard different from the control device.

Other features and advantages of the invention will appear from the following description of embodiments of the invention, given by way of example only, and with reference to the drawings which are:

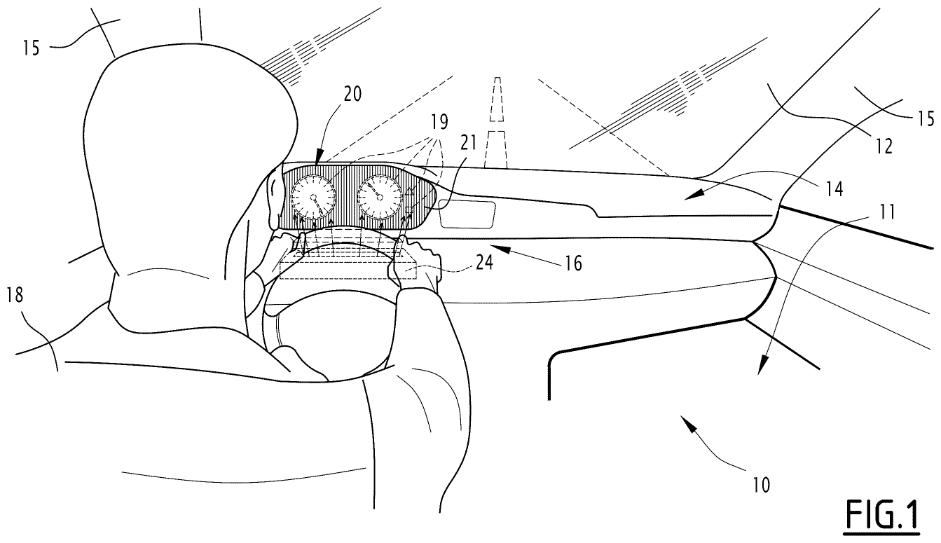

FIG. 1, a schematic representation of an example of a vehicle interior wherein a control device is integrated according to a first integration mode,

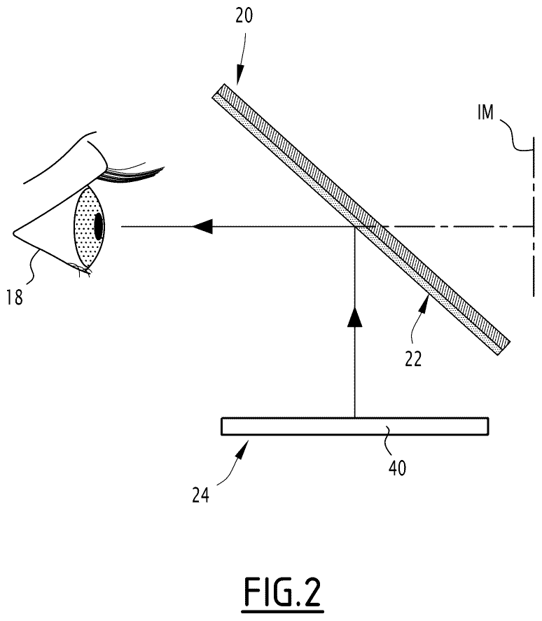

FIG. 2, a schematic representation of an example of a control device,

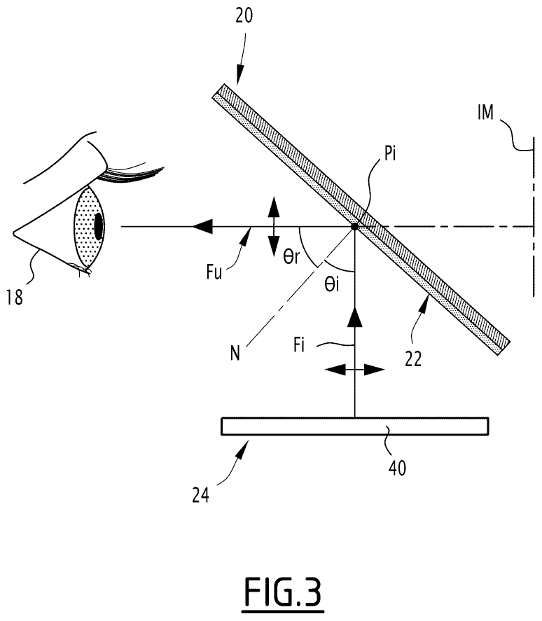

FIG. 3, a schematic representation of another example of a control device,

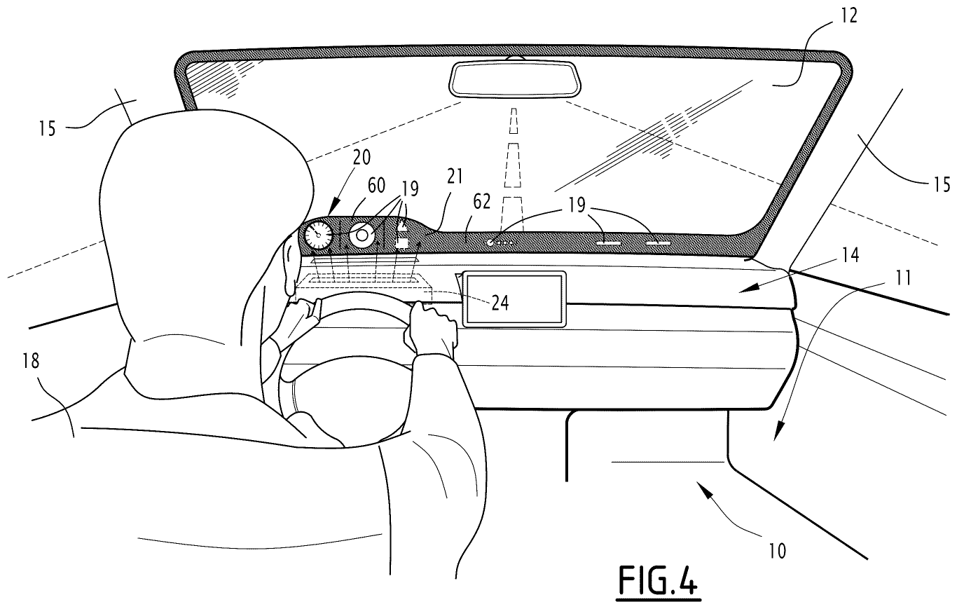

FIG. 4, a schematic representation of an example of an interior wherein a control device is integrated according to a second integration mode, and

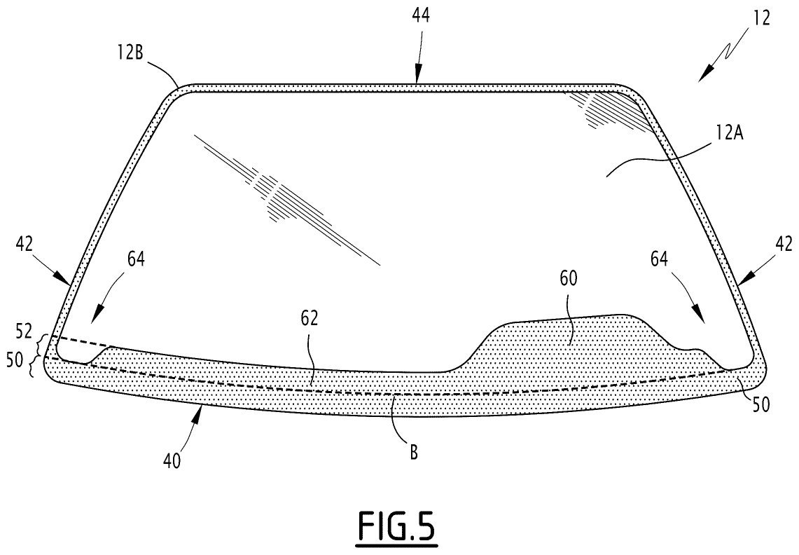

FIG. 5, a schematic representation of a windshield (visible from the outside) of the vehicle according to the second integration mode.

A vehicle 10 is illustrated by FIG. 1.

In this example, the vehicle 10 comprises, in an interior 11, a windshield 12, a dashboard 14, pillars 15, and a control device 16.

The vehicle 10 is, e.g., a land, air, or naval vehicle. The land vehicle is, e.g., an automobile (FIG. 1), a rail vehicle, or even a two-wheeler.

The dashboard 14 is defined as a surface extending across the entire width of the vehicle 10, below the windshield 12 and above the feet of the driver 18 and, if applicable, the front passenger.

The pillars 15 are connected to the windshield 12 and to the roof of the vehicle 10.

In the integration mode of FIG. 1, the control device 16 is integrated into the dashboard 14 of the vehicle 10. By the term “integrated,” it is understood that the control device 16 is incorporated in a manner adapted to the dashboard 14. Such incorporation was, e.g., carried out during the design of said dashboard 14 (in the industrialization phase of the vehicle 10). The control device 16 is therefore different from a device installed as an aftermarket and which would have only been placed in the vehicle 10 without specific incorporation into the dashboard 14. The control device 16 is suitable for displaying control information of the vehicle 10, including all the dashboard instruments 19 of the vehicle.

The dashboard instruments 19 are indicators or warning lights that inform the driver 18 of a vehicle 10 about driving parameters (speed, acceleration, temperature, etc.) and the operation of the vehicle 10, notably the engine of the vehicle 10. For an automobile, the dashboard indicators comprise, e.g., at least a tachometer, a speedometer, a fuel gauge, and a coolant temperature indicator.

Optionally, the control device 16 is also suitable for displaying useful driving information such as navigation (mapping, positions, directions); traffic conditions (traffic jams, roadworks), or more generally driver assistance systems (ADAS for “Advanced Driving Assistant Systems”). Optionally, the control device 16 is also suitable for displaying other information such as multimedia services or information related to the air conditioning of the vehicle.

Advantageously, the control device 16 is the only element integrated into the vehicle 10 displaying the dashboard instruments 19. The vehicle 10 is thus devoid of integrated mechanical dashboard instruments or other integrated digital means of displaying the dashboard instruments.

Advantageously, the control device 16 is configured to be automatically turned on when the vehicle 10 is started (i.e., when the engine of the vehicle is started) and to be automatically turned off when the vehicle 10 is turned off (engine shut-down).

As illustrated by FIG. 2, the control device 16 comprises an opaque panel 20, a reflective element 22, and an emission unit 24 for control information of the vehicle 10.

By the term “opaque,” it is understood to mean zero transparency.

Preferably, the opaque panel 20 is black, which allows for obtaining useful images with better contrast.

Preferably, the opaque panel 20 is made of glass or plastic. In the case of glass, the glass (e.g., the windshield) forming the opaque panel 20 is, e.g., covered with a ceramic conferring opacity. In the case of plastic, the plastic forming the opaque panel 20 is, e.g., tinted or covered with a film conferring opacity.

The opaque panel 20 has a useful surface 21, at least part of which is suitable for being positioned opposite the upper body (torso, head) of a driver 18 in the driving position.

In an implementation example, the useful surface 21 extends over the entire extent of the dashboard, i.e., also opposite the passenger seat in the case of an automobile. More generally, the useful surface 21 advantageously also has a part that is not opposite the driver in the driving position.

The useful surface 21 is preferably flat, which reduces aberrations and provides a larger observation window than a concave surface. Alternatively, the or at least part of the useful surface 21 is concave.

The reflective element 22 covers the useful surface 21 of the opaque panel 20.

The reflective element 22 is at least partially reflective.

The reflective element 22 is, e.g., a coating or treatment (e.g., obtained by physical or chemical deposition) or a film (e.g., laminated or held by electrostatic effect).

The emission unit 24 is suitable for emitting at least one light beam towards the reflective element 22 so that the reflection of the light beam by the reflective element 22 forms at least one useful virtual image in an observation window of the driver 18 in the driving position.

The light beam is, e.g., in the visible wavelength range (380 nanometers to 700 nanometers). The useful image thus allows the driver 18 to visualize the control information of the vehicle 10.

Preferably, the emission unit 24 comprises at least one screen 40 on which an image is displayed. The at least one useful image is then a virtual image IM of the image displayed on the screen 40. Such a virtual image IM is obtained by reflection of the beam from the screen 40 onto the reflective element 22 (due to the semi-reflective property of the reflective element 22).

The screen 40 is, e.g., a liquid crystal display (LCD).

Advantageously, the control device 16 is devoid of optics on the path of the light beam between the emission unit 24 and the reflective element 22, which allows for compactness and does not restrict the observation window.

An example of the operation of the control device 16 integrated into the vehicle 10 will now be described.

Advantageously, the control device 16 is automatically turned on when the vehicle 10 is started and is automatically turned off when the vehicle 10 is turned off.

During driving, the emission unit 24 sends information in the form of a light beam towards the reflective element 22, which then forms a useful image comprising useful information for driving the vehicle 10.

Thus, the control device 16 allows useful driving information (control, navigation, traffic conditions) to be displayed without affecting driving safety since the windshield 12 is not obscured. Such a control device 16 is compact and easily integrable into the dashboard 14 of the vehicle 10. Thus, in this embodiment, the opaque panel 20 is different from the windshield of the vehicle 10 (since the control device 16 is intended to be integrated into the dashboard 14 of the vehicle).

Moreover, such a control device 16 allows the useful image to be observed in a larger and therefore more comfortable observation window (eyebox) than a head-up display.

Moreover, due to the opacity of the opaque panel 20, better contrast is obtained for the useful image compared to a transparent panel. It is thus possible to reduce the brightness of the emission unit 24 (e.g., reducing from 12000 nits, which is the current minimum standard for head-up displays, to 6000 nits or less, a reduction by a factor of 2), which facilitates the creation of the control device 16, reduces heating, and results in an energy savings compared to a transparent panel.

In the following, an embodiment of the control device is described, referring to FIG. 3, which optionally supplements the embodiment described hereinabove.

In this embodiment, the reflective element 22, also called a reflective polarizer, is an element suitable for reflecting an incident light beam F_{I} having a given range of wavelengths, depending on the angle of incidence ⊖i of the incident beam F_{I} on the reflective element 22 and the polarization of said incident beam F_{I}.

The given range of wavelengths of the incident beam F_{I} belongs, e.g., to the visible domain (380 nanometers to 700 nanometers).

The angle of incidence ⊖ᵢ of the incident beam F_{I} is the angle between the beam axis and the normal N to the reflective element 22 at the point of incidence P_{I} of the incident beam F_{I} on the reflective element 22. The axis of the incident beam F_{I} and the normal N to the reflective element 22 at the point of incidence P_{I} define a plane of incidence. In the example illustrated by FIG. 3, the plane of incidence is the plane of the figure. Notably, the reflective element 22 is suitable for reflecting the incident beam F_{I} to form a useful virtual image observable from an observation window (corresponding to a useful beam F_{U}).

In the following, a rectilinear polarization contained in the plane of incidence is also called P polarization, and a rectilinear polarization perpendicular to the plane of incidence is also called S polarization.

The reflective element 22 is optimized to reflect P-polarized light.

Preferably, the reflective element 22 has greater reflectivity, over a range of angles of incidence and over the given wavelength range, for P-polarized light than for differently polarized light (S, circular, elliptical polarization).

In a variant (notably on an industrial scale), the reflective element 22 has optimized reflectivity for P-polarized light compared to reflection on a non-specifically optimized reflective element. However, the reflectivity of the reflective element 22 remains greater, over a range of angles of incidence and over the given wavelength range, for S-polarized light than for P-polarized light.

Preferably, the reflectivity of the reflective element 22 for P-polarized light, over the range of angles of incidence and over the given wavelength range, is greater than or equal to 10 percent, preferably greater than or equal to 15 percent, advantageously greater than or equal to 20 percent, advantageously greater than or equal to 40 percent.

Advantageously, the reflectivity of the reflective element 22 for light polarized differently from P polarization, over the range of angles of incidence and over the given wavelength range, is less than or equal to 10 percent, preferably less than or equal to 5 percent.

Advantageously, the range of angles of incidence extends over at least 20 degrees, preferably at least 40 degrees, advantageously at least 60 degrees.

The reflective element 22 comprises, e.g., a stack of dielectric layers.

The reflective element 22 is, e.g., a polarizer having specific reflectivity for P-polarized light, as described in patent application WO 96/19347 A.

In particular, the reflective element 22 comprises, e.g., a multilayer polymer film comprising layers of a crystalline or semi-crystalline naphthalene dicarboxylic acid polyester, e.g., a 2,6-polyethylene naphthalate (“PEN”) or a copolymer derived from ethylene glycol, naphthalene dicarboxylic acid, and certain other acids such as terephthalate (“co-PEN”), with a positive optical stress coefficient, i.e., when stretched, the refractive index thereof in the stretching direction increases, having an average thickness of more than 0.5 microns; and layers of a second selected polymer, e.g., a polyethylene terephthalate (“PET”) or a co-PEN, having an average thickness not exceeding 0.5 microns. In another example, the reflective element 22 comprises a multilayer polymer film comprising layers of a crystalline or semi-crystalline polyester, e.g., a PET, having an average thickness of no more than 0.5 microns; and layers of a second selected polymer, e.g., a polyester or polystyrene, having an average thickness of no more than 0.5 microns; wherein said film has been stretched in at least one direction to at least twice the unstretched dimension of that direction.

In an example of implementation, the reflective element 22 also has at least one coating conferring additional optical and/or mechanical properties. The coating is, e.g., thermal protection, a neutralizing colorimetric treatment, or even an anti-scratch or anti-fog coating.

The emission unit 24 is suitable for emitting an incident light beam on the reflective element 22. The incident beam F_{I} carries information that is, e.g., as described hereinabove.

The incident beam F_{I} emitted by the emission unit 24 is a beam polarized according to a specific polarization, called the main polarization.

The main polarization called P polarization is a rectilinear polarization contained in the plane of incidence. The main polarization is thus different from S polarization, circular polarization, or elliptical polarization.

The wavelengths of the incident beam F_{I} are in the given wavelength range for the reflective element 22, typically in the visible.

The emission unit 24 is configured so that the incident beam F_{I} arrives on the reflective element 22 with an angle of incidence ⊖ᵢ within the range of angles of incidence defined hereinabove for the reflective element 22.

The operation of the control device 16 according to this embodiment is similar to that of the general case, with the differences in operation residing in the polarization of the beam sent by the emission unit 24, as well as in the optimized reflection of the reflective element 22 for P-polarized light.

Thus, this specific embodiment has the advantage of being compatible with polarized sunglasses. Such glasses are indeed classically configured to transmit only P-polarized light and reject other types of polarizations. The combination of a specific polarization of the beam sent by the emission unit 24 and the optimized reflection of the reflective element 22 thus allows the reflection and therefore the visibility of the useful image to be optimized through polarized sunglasses.

A second way of integrating the control device 16 into the vehicle 10 is given with reference to FIGS. 4 and 5. The second way of integrating has the same features and variants as those of the first way of integrating (illustrated in FIG. 1) except for the features hereinbelow. The second way of integrating is therefore described by difference with the first way of integrating, and identical features are not repeated. In particular, the features described in relation to FIGS. 2 and 3 also apply here.

In the second way of integrating, the control device 16 is not integrated into the dashboard 14 of the vehicle but uses elements of the windshield 12.

In particular, as illustrated in detail in FIG. 5, the windshield 12 comprises a transparent surface 12A and a screen-printed area 12B surrounding the transparent surface 12A.

The screen-printed area 12B is an opaque area.

The screen-printed area 12B is typically made of ceramic.

The screen-printed area 12B comprises a lower part 40, two lateral parts 42, and an upper part 44.

The lower part 40 of the screen-printed area 12B comprises a base 50 and a raised portion 52 with respect to the base 50. The base 50 and the raised portion 52 are typically made of the same material.

The base 50 is typically a strip extending substantially over the width of the transparent surface 12A (thus over the extent of the windshield 12). The base 50 is common to all windshields.

The raised portion 52 forms the opaque panel 20. In particular, the surface of the raised portion 52 oriented towards the interior of the vehicle 10 forms the useful surface 21 of the opaque panel 20. The raised portion 52 is thus a specificity of this way of integrating allowing control information to be displayed on the windshield 12. The maximum height of the raised portion 52 is typically below the standards provided for opaque bases of windshields so as not to obstruct the driver's vision 18.

Preferably, the raised portion 52 comprises at least one raised area 60 opposite the upper body of a driver 18 in the driving position.

Preferably, the raised portion 52 comprises a strip 62 protruding from the base 50 and extending substantially over the width of the transparent surface 12A except for the edges 64 which are clear. In other words, the raised portion 52 does not extend over areas of the base 50 adjacent to the pillars 15 of the vehicle. This allows the visibility of the environment at the pillars 15 of the vehicle to be left clear.

Preferably, the raised area 60 is an area more raised than the strip 62 and protruding from the strip 62. The raised area 62 provides access to a larger display surface at the driver 18.

Alternatively, the raised portion 52 only comprises the raised area 60.

Alternatively, the raised portion 52 has a different design or shape depending on the desired head-up display for the vehicle 10.

The operation and advantages of the second way of integrating are the same as those described hereinabove for the first way of integrating and variants thereof.

The second way of integrating also has the advantage of further optimizing space in the vehicle and simplifying the design of the dashboard, which is not modified to integrate the opaque panel 20. Ergonomics and visibility are also improved since the dashboard information is displayed directly on the opaque portion of the windshield (thus in the field of vision of the driver and with good contrast).

A person skilled in the art will understand that the previously described embodiments are may be combined with each other.

A person skilled in the art will also understand that the present description is based on the specific case of automobiles, but the invention is not limited to this type of vehicle. The control device is thus adaptable to all types of vehicles, notably air and naval.

1. A control device suitable for integration into a vehicle to display control information of the vehicle including all the dashboard instruments of the vehicle, the control device comprising:
a. an opaque panel having a useful surface, at least part of which is suitable for being positioned opposite the upper body of a driver in the driving position,
b. a reflective element covering the useful surface of the opaque panel, the reflective element being at least partially reflective, and
c. an emission unit for control information of the vehicle, the emission unit being suitable for emitting at least one light beam towards the reflective element so that the reflection of the light beam on the reflective element forms at least one useful image in an observation window of the driver in the driving position.

2. The control device according to claim 1, wherein the vehicle comprises a windshield comprising a transparent surface and a screen-printed area surrounding the transparent surface the screen-printed area comprising a lower part having a base and a raised portion protruding from the base, the opaque panel being formed by the raised portion.

3. The control device according to claim 2, wherein the vehicle comprises pillars connected to the lateral portions of the base if the windshield, the raised portion comprising a strip protruding from the base and extending substantially over the width of the transparent surface except for the ends of the base of the screen-printed area which are clear, so as to clear the visibility of the environment at the pillars of the vehicle.

4. The control device according to claim 3, wherein the raised portion comprises a raised area more raised than the strip and protruding from the strip, the raised area being an area opposite the upper body of the driver in the driving position.

5. The control device according to claim 1, wherein the control device is suitable for integrating into the dashboard of the vehicle.

6. The control device according to claim 1, wherein the emission unit is suitable for emitting, towards the reflective element, a polarized light beam according to a main polarization, called the incident beam, the incident beam arriving on the reflective element with an angle of incidence and defining with the reflective element a plane of incidence, the main polarization being a polarization contained in the plane of incidence, called P polarization, the reflective element being optimized to have greater reflectivity, over a range of angles of incidence comprising the angle of incidence, for P-polarized light than a non-optimized reflective element.

7. The control device according to claim 6, wherein the reflective element has greater reflectivity, over the range of angles of incidence, for P-polarized light than for differently polarized light.

8. The control device according to claim 1, wherein the control device is configured to be automatically turned on when the vehicle is started and to be automatically turned off when the vehicle is turned off.

9. A vehicle wherein a control device according to claim 1 is integrated.

10. The vehicle according to claim 9, wherein the dashboard is devoid of mechanical dashboard instruments integrated into the dashboard and digital dashboard instruments integrated into the dashboard different from the control device.
